(19) United States
(12) Patent Application Publication
(10) Pub. No.: US 2026/0220605 A1
(43) Pub. Date: Jul. 30, 2026

(54) Operator Management Control Method, Apparatus and System

(71) Applicant: 1959612 ONTARIO INC., Aurora (CA)

(72) Inventor: Abbas Dhanji, Oakville (CA)

(21) Appl. No.: 19/039,276

(22) Filed: Jan. 28, 2025

(51) Int. Cl. G06Q 10/10; G05B 9/02; G06Q 10/067

(52) U.S. Cl. CPC G06Q 10/103; G05B 9/02; G06Q 10/067

(57) ABSTRACT

A method, computer program product, and system provide for managing operator usage of equipment. On a mobile electronic device, a machine number is selected corresponding to a permitted machine and an organization policy form to be signed by the operator is provided. Upon receiving a signature from the operator, a pre-use inspection form is provided to be completed by the operator. Upon receiving a completed pre-use inspection form, the machine is allowed to be enabled and used by the operator. The operator may then enable the machine to operate the machine at this time. A post-use form to be completed by the operator is provided on the mobile electronic device for the operator’s input after use of the machine. Upon receiving a completed post-use form, the machine is allowed to be disabled by the operator. At this time, the operator’s command to disable the machine will then disable the machine.

The present embodiments relate to a control method, apparatus, and system of equipment management and control. More specifically, the embodiments relate to a control method, apparatus, and system to manage operator usage to enforce accountability towards equipment usage and to ensure compliance and cost savings.

### BACKGROUND

In industrial and commercial environments, the effective use and management control of equipment are critical to ensuring operational efficiency, safety, and cost-effectiveness. Tracking operator usage of equipment, setting compliance requirements, and enforcing accountability among operators are vital components of a well-functioning system. These practices not only protect the organization’s investments but also promote a culture of accountability, safety, and continuous improvement.

Tracking equipment usage by operators is essential for several reasons. First, it provides valuable data on the performance and condition of the equipment. Operators often use machines in ways that impact wear and tear, and by monitoring usage, organizations can identify patterns that may lead to premature equipment failure. This allows organizations to ensure accountability and apply potential back charges to contain operating costs. Second, tracking usage ensures that the equipment is being used as intended. It can ensure operators adhere to regulatory compliance requirements or if improper handling is occurring. For example, overloading machinery or using it outside its designed capacity can lead to safety hazards and expensive repairs. Monitoring operators’ actions can minimize exposure to liability for non-compliance, contain costs with potential charges to operators and crews, and extend the lifespan of the equipment.

Moreover, usage data allows for performance benchmarking. By analyzing how different operators use the same equipment, organizations can identify best practices and areas where additional training may be required. This fosters continuous accountability and ensures that all team members meet a consistent standard of performance.

Establishing clear compliance requirements for equipment usage is another critical aspect of managing resources effectively. Compliance requirements act as a framework that operators and organizations must adhere to, ensuring uniformity and reducing risks. These requirements typically include guidelines on operating procedures, safety measures, and maintenance protocols. Compliance standards are particularly important for ensuring safety. Many types of equipment come with inherent risks, and misuse can lead to accidents or injuries. By setting detailed safety requirements, organizations minimize the likelihood of such incidents. For instance, specifying personal protective equipment (PPE) requirements, load limits, or inspection routines ensures that operators are well-prepared to use the equipment safely and compliant with regulatory requirements.

Additionally, compliance requirements help organizations meet regulatory standards. Industries such as construction, manufacturing, and transportation are subject to strict laws regarding equipment use. Non-compliance with such regulations can result in significant fines, legal action, and reputational damage. By enforcing internal compliance measures, organizations can align with external regulations and demonstrate their commitment to safety and professionalism.

Accountability is the cornerstone of any system designed to manage equipment effectively. Without accountability, even the best tracking systems and compliance requirements will fall short. Enforcing accountability ensures that operators take their responsibilities seriously and understand the consequences of non-compliance. One way to enforce accountability is through clear documentation and reporting processes. Operators should log their usage, report any issues promptly, and adhere to established protocols. Digital tools, such as equipment management software, can simplify these processes by automating tracking and reporting. These tools also create an auditable trail, making it easier to identify and address any deviations from standard practices.

Another key aspect of accountability is performance evaluation. Regular reviews of operator behavior and adherence to compliance standards help identify both exemplary performance and areas needing improvement. Recognizing operators who consistently follow guidelines can reinforce positive behavior, while addressing lapses promptly prevents further issues.

In many cases, upholding the effective use and maintenance of equipment adds time to an operation and increases the downtime with which the equipment is not being run by an operator. Accordingly, there is a need for a streamlined and autonomous method, apparatus, and/or system that ensure that only an authorized operator is allowed to operate the intended equipment, the operator has followed compliance requirements for operation of the equipment, and that accountability for the operation of the intended equipment is correctly and efficiently prescribed to the operator.

### SUMMARY

A computer-implemented method, apparatus and system are disclosed for managing operator usage of equipment.

In one embodiment, a method is provided whereby the method includes selecting, on a mobile electronic device, at least one machine number corresponding to a machine permitted to be operated by an operator and providing on the mobile electronic device, an organization policy form to be electronically signed by the operator.

Upon receiving a signature from the operator, a pre-use inspection form is provided to be completed by the operator on the mobile electronic device. Upon receiving a completed pre-use inspection form, the machine is allowed to be enabled and used by the operator. The operator may then enable the machine to operate the machine at this time.

A post-use form to be completed by the operator is provided on the mobile electronic device for the operator’s input after use of the machine. Upon receiving a completed post-use form, the machine is allowed to be disabled by the operator. At this time, the operator’s command to disable the machine will then disable the machine.

In another embodiment, a computer program product for managing operator usage of equipment is provided. The computer program product includes a non-transitory computer readable storage device having program code embodied therewith that is executable to select, on a mobile electronic device, at least one machine number corresponding to a machine permitted to be operated by an operator and provide on the mobile electronic device, an organization policy form to be electronically signed by the operator.

Upon receiving a signature from the operator, the program code is executable to provide a pre-use inspection form to be completed by the operator on the mobile electronic device. Upon receiving a completed pre-use inspection form, the program code is executable to allow the machine to be enabled and used thereafter by the operator.

The program code is executable to provide a post-use form to be completed by the operator on the mobile electronic device for the operator’s input after use of the machine. Upon receiving a completed post-use form, the program code is executable to allow the machine to be disabled by the operator. At this time, the operator’s command to disable the machine will then disable the machine.

In yet another embodiment, a computer system for managing operator usage of equipment is provided. The computer system includes an equipment management server in communication with a database, whereby the database includes at least one machine number corresponding to a machine, a machine management tool affixed to the machine and in communication with a receiver and the equipment management server, and an operator communication device having a processor, a memory, and a transceiver which is in communication with the equipment management server.

The operator communication device is configured to select at least one machine number corresponding to the machine permitted to be used and provide an organization policy form to be electronically signed by an operator. Upon receiving a signature from the operator, the operator communication device is configured to provide a pre-use inspection form to be completed by the operator. Upon receiving a completed pre-use inspection form, the operator communication device is configured to allow the machine to be enabled and used by the operator. The operator communication device is further configured to enable the machine by sending an enabling command to the machine management tool via the equipment management server and thereafter provide a post-use form to be completed by the operator. Upon receiving a completed post-use form, the operator communication device is configured to allow the machine to be disabled and then disable the machine by sending a disabling command to the machine management tool via the equipment management server.

These and other features and advantages will become apparent from the following detailed description of the presently preferred embodiment(s), taken in conjunction with the accompanying drawings.

### BRIEF DESCRIPTION OF THE DRAWINGS

The drawings reference herein forms a part of the specification. Features shown in the drawings are meant as illustrative of only some embodiments, and not of all embodiments unless otherwise explicitly indicated.

FIG. 1 depicts a method for managing operator usage of machine equipment, in accordance with an embodiment of the invention;

FIG. 2 depicts a system for managing operator usage of machine equipment, in accordance with an embodiment of the invention;

FIG. 3A depicts a first page of a first Pre-Use Inspection Form, in accordance with an embodiment of the invention;

FIG. 3B depicts a second page of a first Pre-Use Inspection Form, in accordance with an embodiment of the invention;

FIG. 3C depicts a third page of a first Pre-Use Inspection Form, in accordance with an embodiment of the invention;

FIG. 3D depicts a fourth page of a first Pre-Use Inspection Form, in accordance with an embodiment of the invention;

FIG. 4 depicts a second Pre-Use Inspection Form, in accordance with an embodiment of the invention; and

FIG. 5 depicts a Post-Use Inspection Form, in accordance with an embodiment of the invention.

### DETAILED DESCRIPTION

It will be readily understood that the components of the present embodiment(s), as generally described and illustrated in the Figures herein, may be arranged and designed in a wide variety of different configurations. Thus, the following detailed description of the embodiments of the apparatus, system, and method of the present embodiment(s), as presented in the Figures, is not intended to limit the scope of the embodiment(s), as claimed, but is merely representative of selected embodiments.

A tool, as referred to herein, may be implemented in programmable hardware devices such as field programmable gate arrays, programmable array logic, programmable logic devices, or the like. A tool may also be implemented in software for execution by various types of processors. An identified tool, as executable code may, for instance, comprise one or more physical or logical blocks of computer instructions which may, for instance, be organized as an object, procedure, function, or other construct. Nevertheless, the executable of an identified tool need not be physically located together but may comprise disparate instructions stored in different locations which, when joined logically together, comprise the tool and achieve the stated purpose of the tool.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Indeed, executable code could be a single instruction, or many instructions, and may even be distributed over several different code segments, among different applications, and across several memory devices. Similarly, operational data may be identified and illustrated herein within the tool and may be embodied in any suitable form and organized within any suitable type of data structure. The operational data may be collected as a single data set or may be distributed over different locations including over different storage devices, and may exist, at least partially, as electronic signals on a system or network.

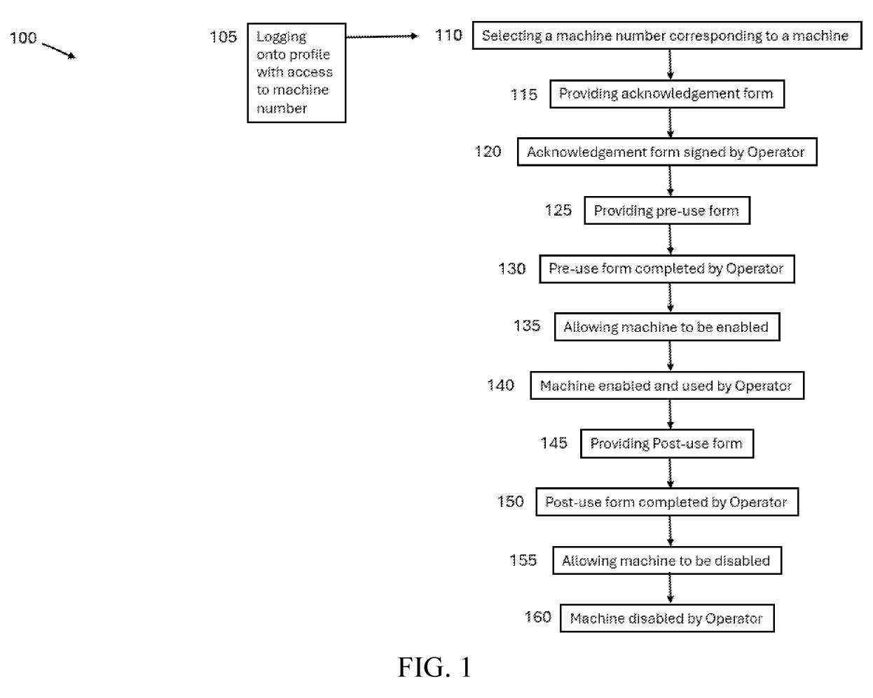

As shown in FIG. 1, method 100 for managing operator usage of machine equipment includes selecting, on a mobile electronic device, a machine number corresponding to a machine to be operated by an operator, 110. The mobile electronic device may correspond to an online account profile having access to the machine number. In one embodiment, an operator may need to log onto the online account profile with the mobile electronic device prior to selecting the machine number corresponding to the machine to be operated. An organization policy form to be electronically signed by the operator is provided on the mobile electronic device, 115.

An organization policy form includes any company/organization specific policies or rules outside of regulatory compliance requirements such as understanding only the authorized operator may operate the assigned machine, reporting damages found from previous operation of the machine, and/or ensuring the machines is left running for a period of time to ensure the battery remains healthy. The organization policy form is then signed by the operator, 120.

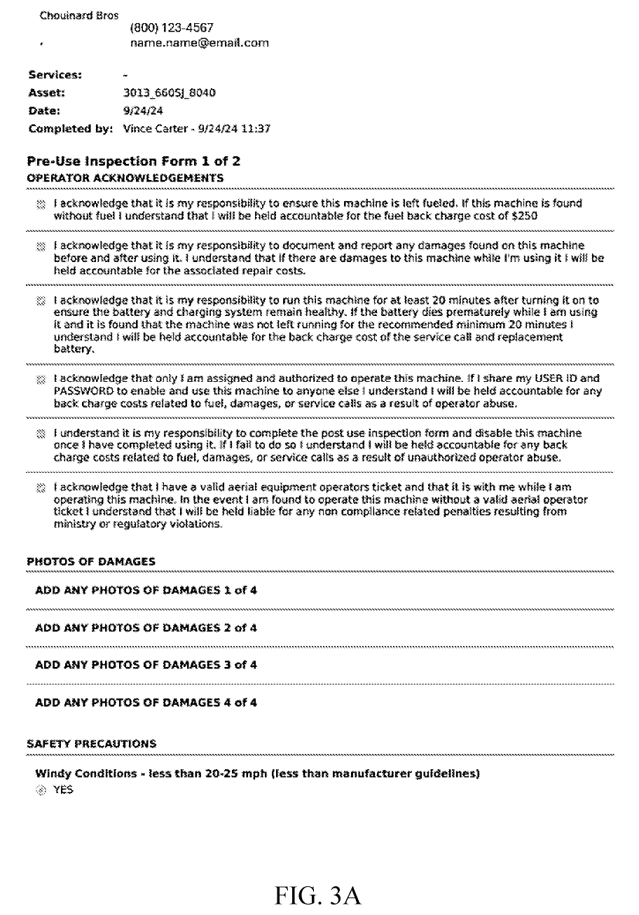

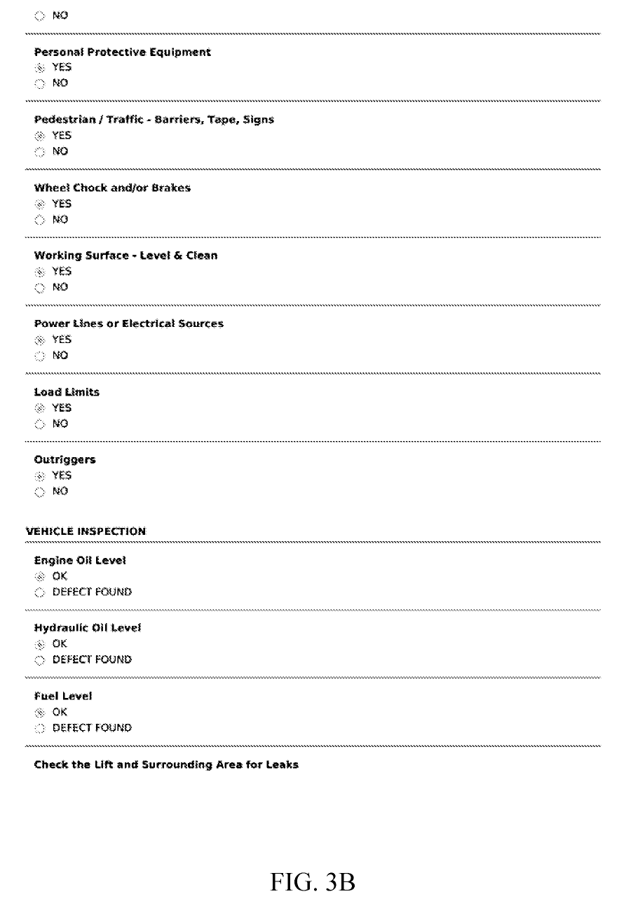

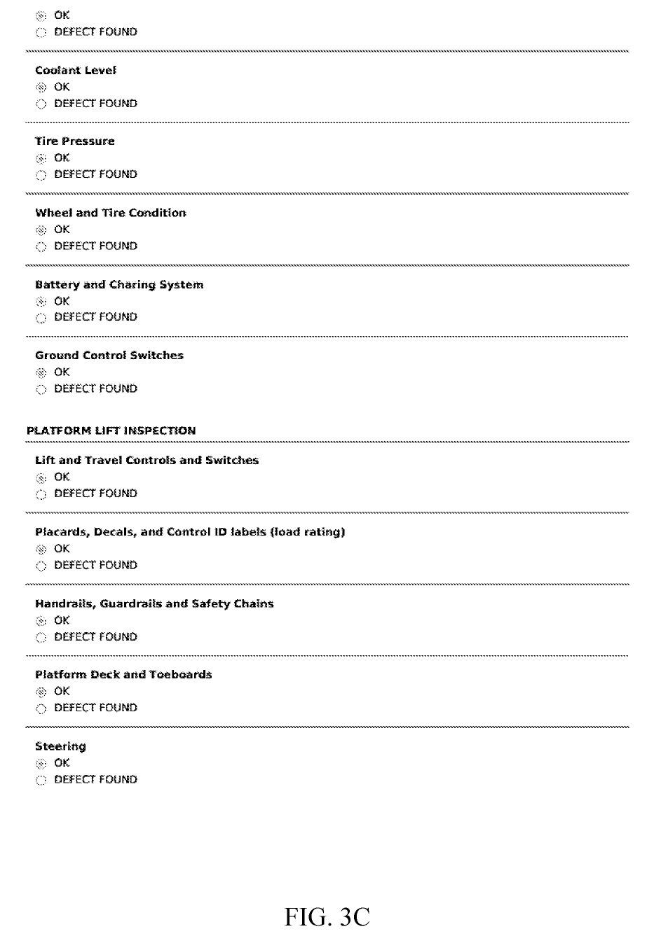

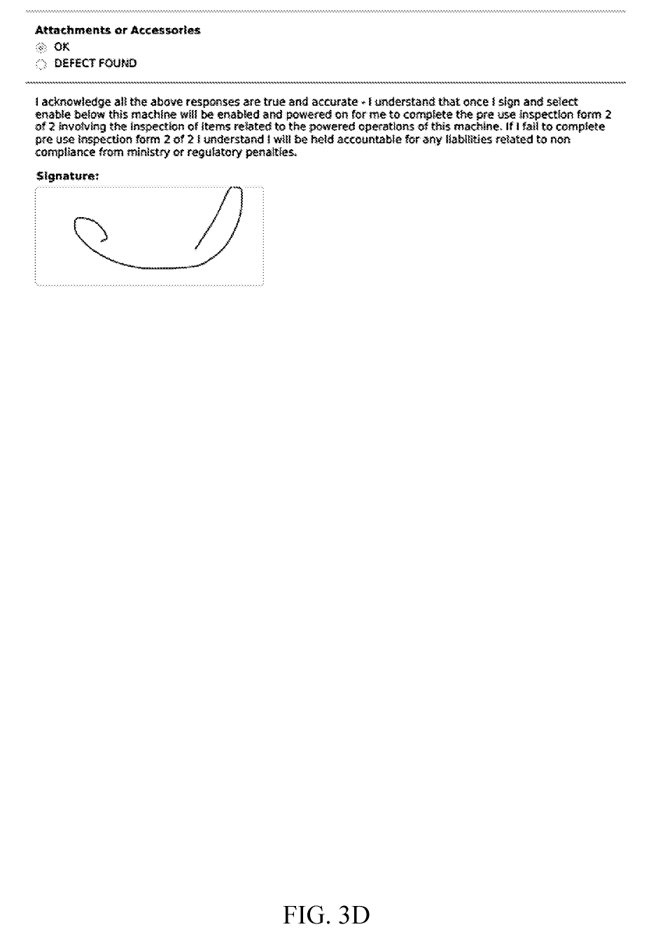

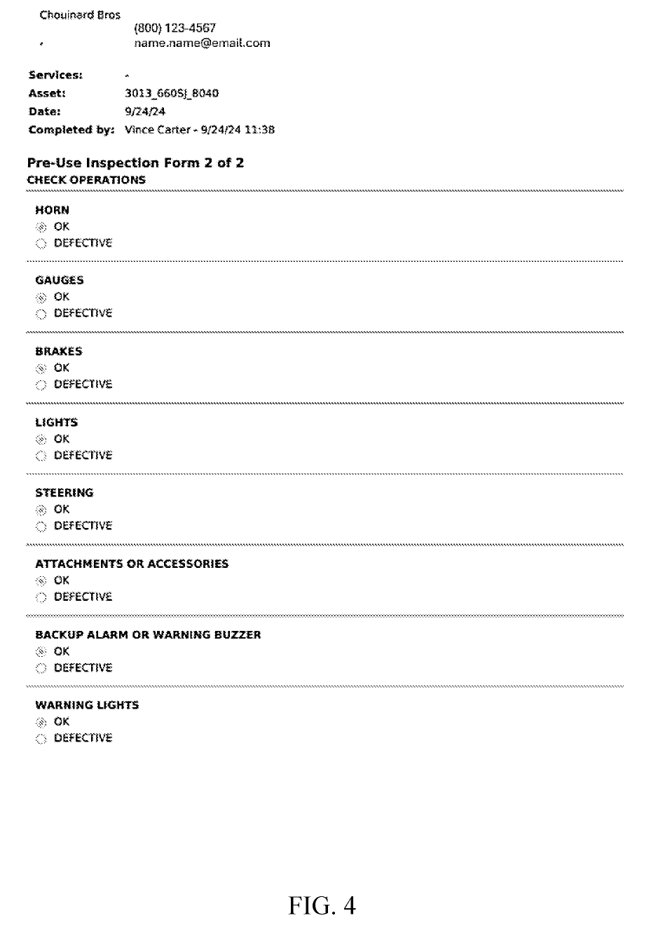

Upon receiving a signature from the operator, a pre-use inspection form is provided to be completed by the operator on the mobile electronic device, 125. A pre-use inspection form may include a regulatory compliance piece outlined by the ministry of labour. Such piece may be specifically related to items defined by the ministry such as safety precaution items, vehicle inspection items, platform lift inspection items, etc. As shown in FIGS. 3A-4, in an embodiment of the invention, the pre-use inspection form includes operator acknowledgements regarding allocation of responsibilities, accountability, and fulfillment of legal and regulatory requirements such as the possession of valid licenses, certifications or tickets. The pre-use inspection form may further include a section whereupon an operator may upload photographs of pre-existing damage of the machine prior to the operator’s use. Moreover, the pre-use inspection form may further include a checklist of safety precautions that an operator must complete before signing the form. The checklist of safety precautions may include confirmations that wind conditions are within a safe predetermined threshold, that the operator is wearing personal protective equipment, that required pedestrian traffic barriers/tape/signs are in place, that engine oil is sufficient, that hydraulic oil is sufficient, that there are no defects found in any controls or switches, or that there are no defects found with the steering system, that the horn, gauges, brakes, and lights have no defects, etc.

The pre-use inspection form is then completed by the operator, 130. Upon receiving a completed pre-use inspection form, the machine is allowed to be enabled and used by the operator, 135. The operator may then enable the machine to operate the machine at this time, 140. In one embodiment, enabling the machine may include electronically engaging a bypass switch to allow the machine to be turned on with a conventional ON/OFF switch.

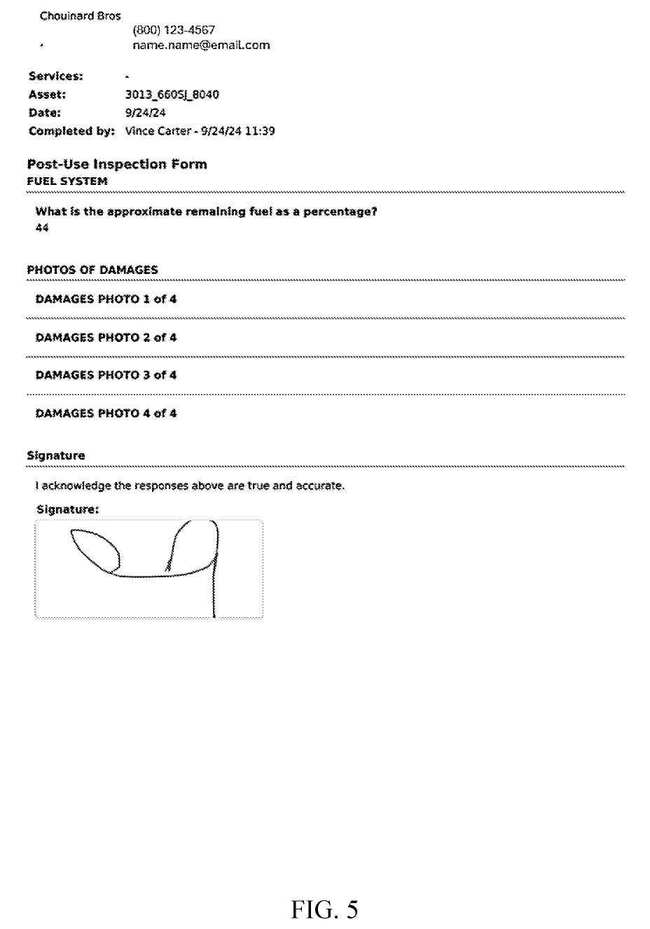

A post-use form to be completed by the operator is provided on the mobile electronic device for the operator’s input after use of the machine, 145. As shown in FIG. 5, the post-use form includes any company/organization specific policies or rules outside of regulatory compliance requirements such as recording the remaining fuel level, mentioning any damages that occurred during use, and/or agreeing that if this machine is not disabled there will be accountability on the current operator for the potential unauthorized use and damages. The post-use form may include a section whereupon the operator may be prompted to enter the remaining fuel amount and photos of any damages to the machine that occurred during the operator’s operation of the machine prior to signing the form.

The post-use form is then completed by the operator, 150. A completed post-use form may include an electronic signature by the operator. Upon receiving a completed post-use form, the machine is allowed to be disabled by the operator, 155. At this time, the operator’s command to disable the machine will then disable the machine, 160. In one embodiment, disabling the machine includes electronically disengaging a bypass switch to turn off a machine, circumventing a conventional ON/OFF switch.

In yet another embodiment, a computer program product for managing operator usage of equipment includes a non-transitory computer readable storage device having program code embodied therewith. The program code is executable by a processor to select, on a mobile electronic device, a machine number (or other unique identifier for the machine) corresponding to a machine to be operated by an operator and provide on the mobile electronic device, an organization policy form to be electronically signed by the operator. The mobile electronic device may correspond to an online account profile having access to the machine number. In an embodiment, the program code is executable by a processor to log onto the online account profile with the mobile electronic device prior to selecting the machine number corresponding to the permitted machine to be operated.

Upon receiving a signature from the operator, the program code is executable to provide a pre-use inspection form to be completed by the operator on the mobile electronic device. The completed post-use form may include an electronic signature by the operator. Upon receiving a completed pre-use inspection form, the program code is executable to allow the machine to be enabled and used thereafter by the operator. Enabling the machine may include electronically engaging a bypass switch to allow the machine to be turned on with a conventional ON/OFF switch.

The program code is executable to provide a post-use form to be completed by the operator on the mobile electronic device for the operator’s input after use of the machine. Upon receiving a completed post-use form, the program code is executable to allow the machine to be disabled by the operator. At this time, the operator’s command to disable the machine will then disable the machine. Disabling the machine may include electronically disengaging a bypass switch to turn off a machine, circumventing a conventional ON/OFF switch.

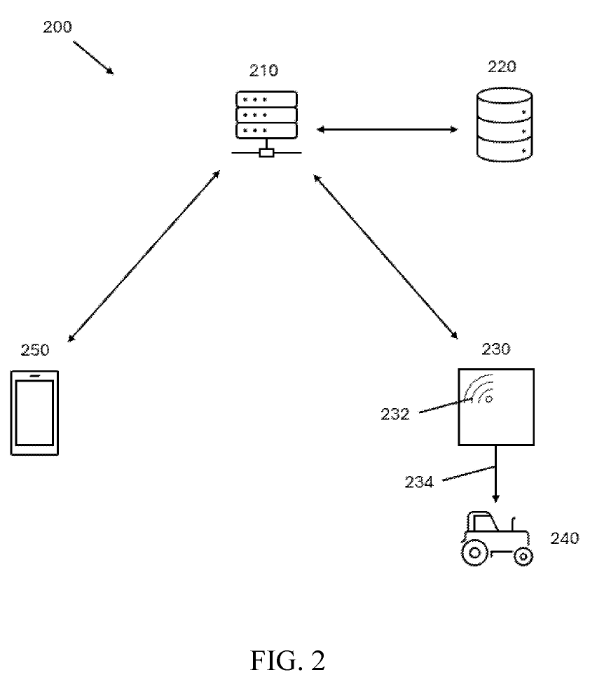

As shown in FIG. 2, an embodiment of the invention is a computer system 200 for managing operator usage of equipment. The computer system 200 includes an equipment management server 210 in communication with a database 220, whereby the database 220 includes a machine number corresponding to a machine 240, a machine management tool 230 affixed to the machine 240 and in communication with a receiver 232 and the equipment management server 210, and an operator communication device 250 having a processor, a memory, and a transceiver which is in communication with the equipment management server 210.

Operator communication device 250 is configured to select the machine number corresponding to the machine 240 and provide an organization policy form to be electronically signed by an operator. The operator communication device 250 may correspond to an online account profile having access to the machine number. The equipment management server 210 may require the online account profile to have been logged into via the operator communication device 250 prior to allowing access to the database 220 by the operator communication device 250. Upon receiving a signature from the operator, the operator communication device 250 is configured to provide a pre-use inspection form to be completed by the operator. Upon receiving a completed pre-use inspection form, the operator communication device 250 is configured to allow the machine 240 to be enabled and used by the operator. The operator communication device 250 is further configured to enable the machine 240 by sending an enabling command to the machine management tool 230 via the equipment management server 210 and thereafter provide a post-use form to be completed by the operator.

Upon receiving the enabling command from the operator communication device 250, the equipment management server 210 may be configured to communicate the enabling command to the machine management tool 230 which may be configured to electronically engage a bypass switch 234 to allow the machine 240 to be turned on with a conventional ON/OFF switch.

Upon receiving a completed post-use form, the operator communication device 250 is configured to allow the machine 240 to be disabled and then disable the machine 240 by sending a disabling command to the machine management tool 230 via the equipment management server 210. The completed post-use form may include an electronic signature by the operator.

Upon receiving the disabling command from the operator communication device 250, the equipment management server 210 may be configured to communicate the disabling command to the machine management tool 230 which may be configured to electronically disengage a bypass switch 234 to turn off the machine 240, circumventing the conventional ON/OFF switch.

The present embodiment(s) may be a system, a method, and/or a computer program product. The computer program product may include a computer readable storage medium (or media) having computer readable program instructions thereon for causing a processor to carry out aspects of the present embodiment(s).

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, a computer readable storage medium, as used herein, is non-transitory.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to the various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiment(s) has been presented for purposes of illustration and description but is not intended to be exhaustive or limited to the embodiment(s) in the form disclosed. Many modifications and variations will be apparent to those of ordinary skill in the art without departing from the scope and spirit of the embodiment(s). The embodiment was chosen and described to best explain the principles and the practical application, and to enable others of ordinary skill in the art to understand the embodiment(s) for various embodiments with various modifications as are suited to the particular use contemplated.

It will be appreciated that, although specific embodiments have been described herein for purposes of illustration, various modifications may be made without departing from the spirit and scope of the invention. In particular, different metrics, hardware components, and virtual components may be used. Accordingly, the scope of protection of this invention is limited only by the following claims and their equivalents.

I claim:

1. A method of managing operator usage of equipment, the method comprising:
selecting, on a mobile electronic device, a machine number corresponding to a permitted machine to be operated by an operator;
providing, on the mobile electronic device, an organization policy form to be electronically signed by the operator;
upon receiving a signature from the operator, providing on the mobile electronic device a pre-use inspection form to be completed by the operator;
upon receiving a completed pre-use inspection form, allowing the permitted machine to be enabled and used by the operator;
enabling the permitted machine;
providing, on the mobile electronic device, a post-use form to be completed by the operator;
upon receiving a completed post-use form, allowing the permitted machine to be disabled; and
disabling the permitted machine.

2. The method of claim 1, wherein enabling the permitted machine includes electronically engaging a bypass switch to allow the permitted machine to be turned on with a conventional ON/OFF switch.

3. The method of claim 1, wherein disabling the machine includes electronically disengaging a bypass switch to turn off the permitted machine, circumventing a conventional ON/OFF switch.

4. The method of claim 1, wherein the mobile electronic device corresponds to an online account profile having access to the machine number.

5. The method of claim 4, further comprising logging onto the online account profile with the mobile electronic device prior to selecting the machine number corresponding to the permitted machine to be operated.

6. The method of claim 1, wherein the completed post-use form includes an electronic signature by the operator.

7. A computer program product for managing operator usage of equipment, the computer program product comprising a non-transitory computer readable storage device having program code embodied therewith, the program code executable by a processor to:
select, on a mobile electronic device, a machine number corresponding to a permitted machine to be operated by an operator;
provide, on the mobile electronic device, an organization policy form to be electronically signed by the operator;
upon receiving a signature from the operator, provide on the mobile electronic device a pre-use inspection form to be completed by the operator;
upon receiving a completed pre-use inspection form, allow the permitted machine to be enabled and used by the operator;
enable the permitted machine;
provide, on the mobile electronic device, a post-use form to be completed by the operator;
upon receiving a completed post-use form, allow the permitted machine to be disabled; and
disable the permitted machine.

8. The computer program product of claim 7, wherein enabling the permitted machine includes electronically engaging a bypass switch to allow the permitted machine to be turned on with a conventional ON/OFF switch.

9. The computer program product of claim 7, wherein disabling the permitted machine includes electronically disengaging a bypass switch to turn off the permitted machine, circumventing a conventional ON/OFF switch.

10. The computer program product of claim 7, wherein the mobile electronic device corresponds to an online account profile having access to the machine number.

11. The computer program product of claim 10, wherein the program code is further executable by the processor to log onto the online account profile with the mobile electronic device prior to selecting the machine number corresponding to the permitted machine to be operated.

12. The computer program product of claim 7, wherein the completed post-use form includes an electronic signature by the operator.

13. A computer system for managing operator usage of equipment, the computer system comprising:
an equipment management server in communication with a database, the database including a machine number corresponding to a permitted machine;
a machine management tool affixed to the permitted machine and in communication with a receiver and the equipment management server;
an operator communication device having a processor, a memory, and a transceiver which is in communication with the equipment management server, the operator communication device being configured to:
select the machine number corresponding to the permitted machine;
provide an organization policy form to be electronically signed by an operator;
upon receiving a signature from the operator, provide a pre-use inspection form to be completed by the operator;
upon receiving a completed pre-use inspection form, allow the permitted machine to be enabled and used by the operator;
enable the permitted machine by sending an enabling command to the machine management tool via the equipment management server;
provide a post-use form to be completed by the operator;
upon receiving a completed post-use form, allow the permitted machine to be disabled; and
disable the permitted machine by sending a disabling command to the machine management tool via the equipment management server.

14. The computer system of claim 13, wherein upon receiving the enabling command from the operator communication device, the equipment management server is configured to communicate the enabling command to the machine management tool and the machine management tool is configured to electronically engage a bypass switch to allow the permitted machine to be turned on with a conventional ON/OFF switch.

15. The computer system of claim 13, wherein upon receiving the disabling command from the operator communication device, the equipment management server is configured to communicate the disabling command to the machine management tool and the machine management tool is configured to electronically disengage a bypass switch to turn off the permitted machine, circumventing a conventional ON/OFF switch.

16. The computer system of claim 13, wherein the operator communication device corresponds to an online account profile having access to the machine number.

17. The computer system of claim 16, wherein the equipment management server requires the online account profile to have been logged into via the operator communication device prior to allowing access to the database by the operator communication device.

18. The computer system of claim 13, wherein the completed post-use form includes an electronic signature by the operator.
